(19) United States
(12) Patent Application Publication
(10) Pub. No.: US 2026/0260190 A1
(43) Pub. Date: Sep. 3, 2026

(54) SYSTEM AND METHOD FOR AUTONOMOUS ORCHESTRATION OF PERISHABLE RESOURCE CAPACITY VIA PREDICTIVE AGENTIC BROKERAGE

(71) Applicant: Dov Glazer, New Orleans, LA (US)

(72) Inventor: Dov Glazer, New Orleans, LA (US)

(21) Appl. No.: 19/670,257

(22) Filed: May 7, 2026

(51) Int. Cl. G06Q 10/0631

(52) U.S. Cl. CPC G06Q 10/06312

(57) ABSTRACT

An autonomous, AI-native system and method for the orchestration and recovery of perishable resource capacity in service-based industries. The system bypasses legacy graphical user interfaces by utilizing API middleware to interface directly with existing scheduling databases. A Natural Language Processing (NLP) layer monitors unstructured communications to predict resource cancellations before they are formally logged. The system converts user profiles into high-dimensional vector embeddings to perform hyper-personalized matching. An autonomous agentic broker, utilizing a Large Language Model (LLM), conducts natural language negotiations, executes variable yield discounting based on real-time resource decay, and facilitates peer-to-peer slot swaps via double-atomic database updates, thereby eliminating human network latency.

### CROSS-REFERENCE TO RELATED APPLICATIONS

This application builds upon and references the foundational scheduling frameworks and concepts originally disclosed in U.S. Pat. No. 7,174,303, issued Feb. 6, 2007 (now expired), which is hereby incorporated by reference in its entirety to establish the baseline of electronic appointment parameterization from which the present autonomous, artificial intelligence-driven orchestration system evolves.

### FIELD OF THE INVENTION

The present invention relates generally to the fields of Artificial Intelligence (AI), Machine Learning (ML), and Resource Optimization. More specifically, it relates to an autonomous, API-first software system that utilizes Natural Language Processing (NLP), Vector Embeddings, and Autonomous Agentic Brokerage to predict resource vacancies and execute multi-party negotiations to optimize capacity in time-perishable, service-based industries.

### BACKGROUND OF THE INVENTION

In service-based economies—such as medical aesthetics, concierge medicine, and localized home services (e.g., HVAC and plumbing)—“time” is a perishing asset. Once a scheduled time slot passes without utilization, the potential revenue from that unit of inventory is permanently lost.

The foundational prior art, notably U.S. Pat. No. 7,174,303, established early graphical scheduling systems utilizing “sponsor parameters” and “priority lists.” However, these legacy systems, and those currently prevalent in the market, are inherently reactive. They require a human “sponsor” (e.g., a receptionist or dispatcher) to manually receive a cancellation, update a digital calendar, and operate a graphical user interface (GUI) to contact replacement candidates. This reliance on human intervention creates high network friction and latency. Consequently, if a cancellation occurs shortly before an appointment time, the latency of human decision-making frequently results in the slot remaining unfilled.

There exists a critical need for a system that solves this “latency of human decision-making” by replacing the traditional GUI-driven workflow with an autonomous broker capable of predictive sensing and real-time execution via API-first integrations.

### SUMMARY OF THE INVENTION

The present invention is an autonomous, AI-native system designed to eliminate “perishing inventory” (unfilled or canceled time slots). The system bypasses manual user input by employing Machine Learning (ML) inference to predict cancellations before they are formally logged.

Upon detecting “intent to cancel” signals within unstructured communications, the system utilizes Vector Embeddings to match the impending opening with high-propensity users. It subsequently deploys an Autonomous Agent to manage dynamic discounting and peer-to-peer slot exchanges. By separating the AI reasoning layer from the service provider's legacy database using API middleware, the system functions as a “plug-and-play” automated marketplace that operates entirely without human intervention.

### BRIEF DESCRIPTION OF THE DRAWINGS

FIG. 1 is a block diagram illustrating the system architecture, including the API Middleware, the NLP layer, and the Autonomous Agentic Broker.

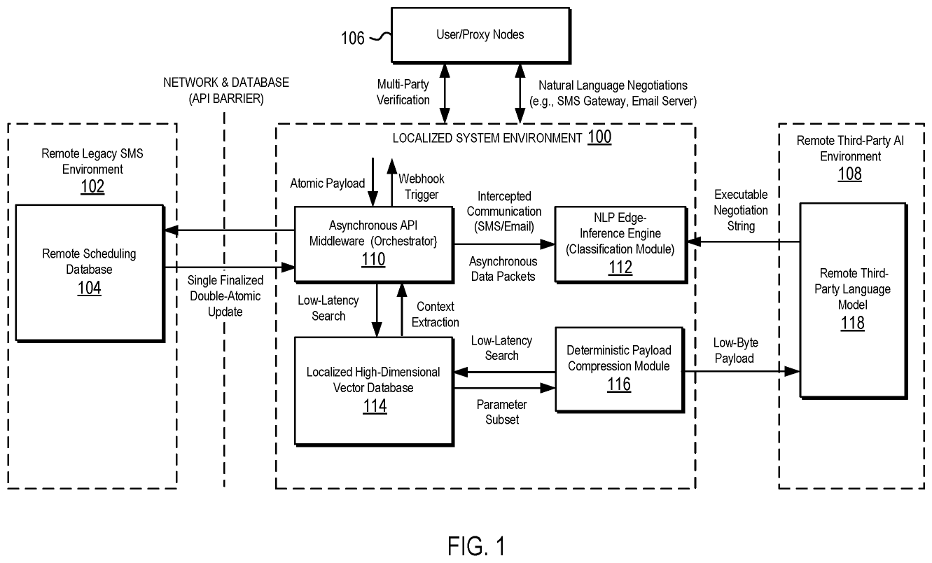

FIG. 2 is a flowchart demonstrating the Predictive “Slot-Sensing” Sentinel process.

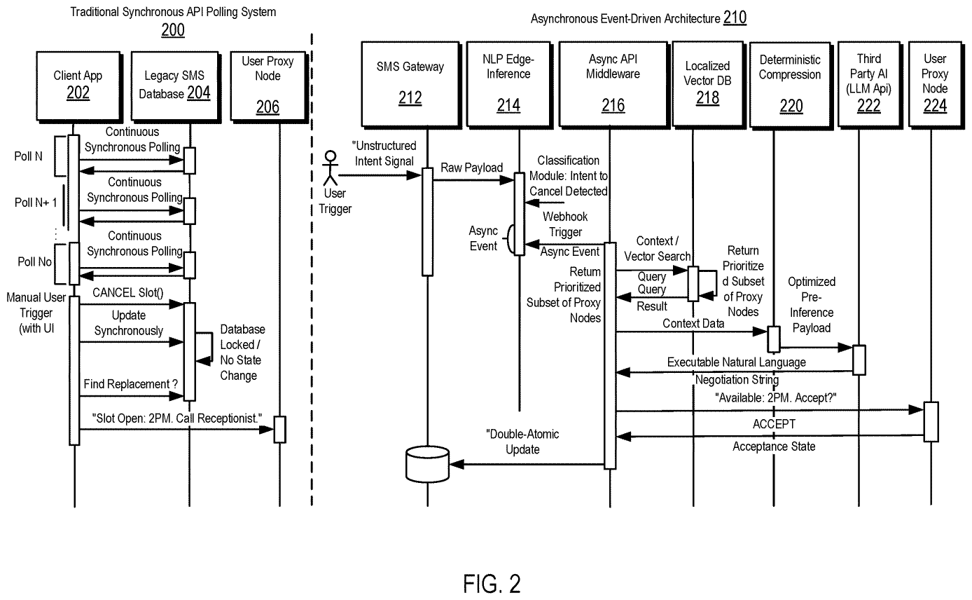

FIG. 3 is a conceptual diagram illustrating the mapping of user profiles into High-Dimensional Vectors for Nearest Neighbor matching.

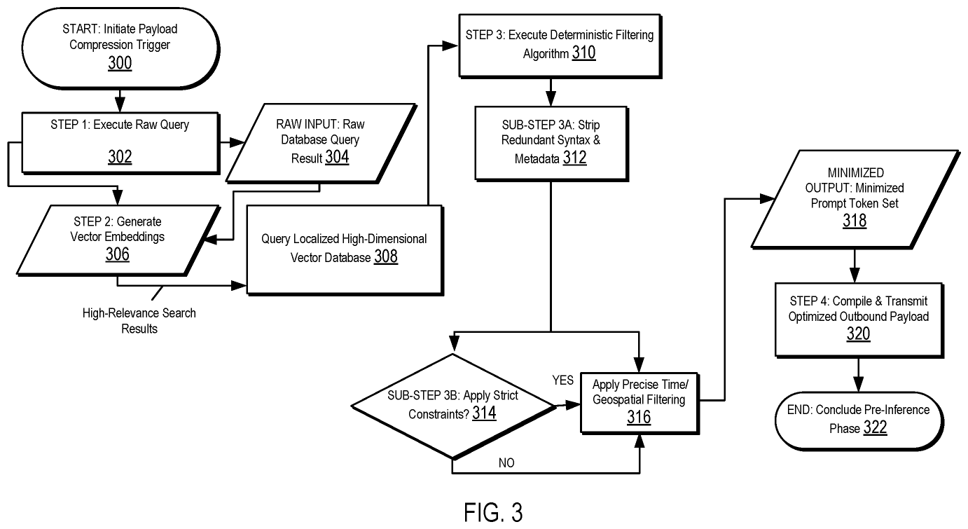

FIG. 4 is a sequence diagram illustrating the double-atomic update utilized during a Peer-to-Peer Slot Swap.

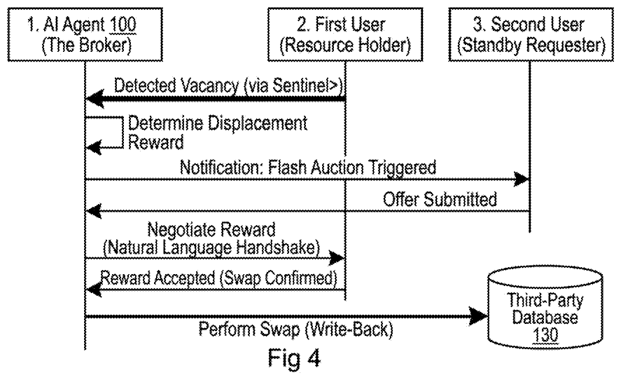

### DETAILED DESCRIPTION OF THE INVENTION

In a preferred embodiment, the system integrates with existing Service Management Software (SMS), such as Dentrix or ServiceTitan, via Webhooks and API middleware. Rather than waiting for a formal calendar cancellation, a Natural Language Processing (NLP) layer monitors incoming unstructured communications (including SMS, email, and voice-to-text transcripts) for “Intent to Cancel” signals. When such intent is detected, the system immediately pre-warms a “Flash Social Network” of interested standby users before the slot is officially vacated. This preemptive action reduces the resource recovery window from hours to seconds.

The present invention evolves the static “Concepts of Interest” described in the '303 patent into dynamic High-Dimensional Vectors. The system maps comprehensive user behavior—including past reliability, geographic proximity, and price sensitivity—into a mathematical vector space. When a time slot becomes available, the system executes a Nearest Neighbor Search. This allows the system to identify a highly specific subset of users (e.g., the top three candidates) who possess the highest statistical probability of accepting the specific service at that precise time, thereby eliminating the inefficiencies of broadcasting to a generic waitlist.

The system implements a Multi-Agent Orchestrator to govern priority dimensions without human oversight. In a first tier, VIP or paid-tier users receive an exclusive window wherein a Large Language Model (LLM) initiates a “Natural Language Handshake” (e.g., an SMS negotiation). Should the slot remain open, the AI agent transitions to a Dynamic Discounting Phase. Here, it autonomously calculates a “Yield Optimization Price.” This algorithmic discount is non-linear; it adjusts based on real-time variables, specifically the probability of the slot remaining empty combined with technician travel costs (geospatial data) and the replacement user's historical propensity-to-pay.

The invention operates as a secondary marketplace for time. If a high-priority user requests a time slot currently occupied by another user, the AI agent autonomously negotiates with the current occupant. The system offers a calculated “Reward” (such as account credit, a discount, or future booking priority) to incentivize the occupant to release the slot for exchange. Upon acceptance of the natural language offer, the AI agent executes a “double-atomic update” via the API middleware across the service provider's calendar, ensuring both schedules are updated simultaneously without data collision.

The system logic is housed in a distinct processing environment utilizing API Middleware to ingest data from legacy scheduling databases. Data storage utilizes specialized vector databases (e.g., Pinecone or PostgreSQL with vector extensions) to manage the high-dimensional user maps. An advanced reasoning engine (e.g., Gemini architecture) manages the semantic parsing and natural language communication layer.

1. (canceled)

2. (canceled)

3. (canceled)

4. (canceled)

5. (canceled)

6. A system for optimizing network latency and reducing computational overhead in distributed scheduling architectures, the system comprising: an asynchronous Application Programming Interface (API) middleware communicatively coupled to a remote scheduling database; a Natural Language Processing (NLP) inference engine configured to monitor unstructured communications and detect a state-change intent signal prior to a formal synchronous update in the remote scheduling database; wherein upon detection of the state-change intent signal, the API middleware is configured to generate an asynchronous webhook event to preemptively trigger a subset of proxy nodes; and wherein the API middleware is configured to execute a double-atomic update to the remote scheduling database via an API integration, thereby bypassing continuous synchronous data polling and resolving multi-party reallocations asynchronously.

7. The system of claim 6, wherein the unstructured communications monitored by the NLP inference engine include at least one of SMS messages, emails, and voice-to-text transcripts.

8. The system of claim 6, further comprising a localized high-dimensional vector database configured to receive the asynchronous webhook event and execute a nearest-neighbor search to identify the subset of proxy nodes based on semantically proximate parameters.

9. The system of claim 6, wherein the double-atomic update executed by the API middleware prevents database locking errors by resolving a multi-party exchange asynchronously prior to transmitting a single finalized update payload to the remote scheduling database.

10. The system of claim 6, further comprising a deterministic payload compression module configured to intercept the asynchronous webhook event prior to transmission to a remote third-party environment; wherein the compression module executes a deterministic filtering algorithm to strip redundant syntax and metadata from a raw database query result, yielding a minimized prompt token set.

11. The system of claim 10, wherein the API middleware compiles the minimized prompt token set into an optimized outbound payload, thereby minimizing network bandwidth consumption and reducing computational processing latency during the asynchronous multi-party reallocation.
